(19) United States
(12) Patent Application Publication
(10) Pub. No.: US 2017/0186112 A1
(43) Pub. Date: Jun. 29, 2017

(54) END TO END USER DEVICE PLATFORM

(71) Applicant: Accenture Global Solutions Limited, Dublin (IE)

(72) Inventor: Srinivasa Polapala, Bangalore (IN)

(21) Appl. No.: 14/980,628

(22) Filed: Dec. 28, 2015

(51) Int. Cl. G06Q 50/14; G06Q 30/06

(52) U.S. Cl. CPC G06Q 50/14; G06Q 30/0631

(57) ABSTRACT

A device may obtain data from a plurality of data sources. The device may automatically evaluate the data to generate a set of recommendations, where each recommendation of the set of recommendations relates to a particular user. The device may provide information identifying the set of recommendations for display via a single user interface. The set of recommendations may relate to activities within a threshold distance of the particular user. The threshold distance may be a travel distance determined based on traffic data. The device may receive information associated with accepting the set of recommendations based on providing the information identifying the set of recommendations. The device may perform a set of response actions for the particular user based on the set of recommendations and after receiving the information associated with accepting the set of recommendations.

### BACKGROUND

A user device may include multiple applications associated with multiple user interfaces. For example, the user device may utilize a mapping application to provide travel directions via a user interface associated with the mapping application. Similarly, the user device may utilize a reviewing application to provide a review of a restaurant, a hotel, a tourist attraction, or the like via a user interface of the reviewing application. The user device may repeatedly request information (e.g., from a server) based on detecting user interactions associated with one or more of the multiple user interfaces.

### SUMMARY

According to some possible implementations, a device may include one or more processors. The one or more processors may obtain data from a plurality of data sources. The one or more processors may automatically evaluate the data to generate a set of recommendations, where each recommendation of the set of recommendations relates to a particular user. The one or more processors may provide information identifying the set of recommendations for display via a single user interface. The set of recommendations may relate to activities within a threshold distance of the particular user. The threshold distance may be a travel distance determined based on traffic data. The one or more processors may receive information associated with accepting the set of recommendations based on providing the information identifying the set of recommendations. The one or more processors may perform a set of response actions for the particular user based on the set of recommendations and after receiving the information associated with accepting the set of recommendations.

According to some possible implementations, a non-transitory computer-readable medium may store one or more instructions that, when executed by one or more processors may cause one or more processors to provide a user interface for display via a user device. The one or more instructions, when executed by the one or more processors, may cause the one or more processors to detect a first one or more user interactions with the user interface. The first one or more user interactions may be associated with specifying one or more user preferences for an activity. The one or more instructions, when executed by the one or more processors, may cause the one or more processors to obtain data regarding a set of potential activities based on the one or more user preferences for the activity and a location of the user device. The one or more instructions, when executed by the one or more processors, may cause the one or more processors to generate updated information based on the set of potential activities. The updated information may be associated with identifying the set of potential activities associated with the location and a recommendation related to the set of potential activities. The one or more instructions, when executed by the one or more processors, may cause the one or more processors to provide the updated information for display via the user interface. The one or more instructions, when executed by the one or more processors, may cause the one or more processors to detect, based on providing the updated information for display via the user interface, a second one or more user interactions with the user interface. The second one or more user interactions may be associated with selecting a plurality of activities of the set of potential activities. The one or more instructions, when executed by the one or more processors, may cause the one or more processors to perform a set of response actions based on detecting the second one or more user interactions with the user interface. The set of response actions may include reserving the plurality of activities and providing, for display via the user interface, directions associated with travel from the location of the user device, to a location of a first activity of the plurality of activities.

According to some possible implementations, a method may include obtaining, by a device, a plurality of data sets relating to a plurality of activities of a plan. The method may include processing, by the device, the plurality of data sets to select the plurality of activities for the plan. The plurality of activities may include a plurality of types of activities. The method may include providing, by the device, a presentation of information relating to the plan via a single user interface of a user device based on selecting the plurality of activities for the plan. The information may relate to the plurality of activities including information identifying directions for traveling to a first activity selected for the plan, of the plurality of activities for the plan, and to a second activity selected for the plan, of the plurality of activities for the plan, from the first activity. The information may relate to the plurality of activities being associated with the plurality of types of activities. The method may include performing, by the device, a set of response actions associated with the plan based on selecting the plurality of activities for the plan. The method may include monitoring, by the device, a location of the user device. The method may include providing, by the device, updated information regarding the plan via the single user interface of the user device based on the location of the user device. The updated information may include updated directions for traveling or an updated selection of activities.

### BRIEF DESCRIPTION OF THE DRAWINGS

FIG. 1 is a diagram of an overview of an example implementation described herein;

FIG. 2 is a diagram of an example environment in which systems and/or methods, described herein, may be implemented;

FIG. 3 is a diagram of example components of one or more devices of FIG. 2;

FIG. 4 is a flow chart of an example process for providing end-to-end location dependent information; and

FIGS. 5A-5E are diagrams of an example implementation relating to the example process shown in FIG. 4.

### DETAILED DESCRIPTION

The following detailed description of example implementations refers to the accompanying drawings. The same reference numbers in different drawings may identify the same or similar elements.

A user device may obtain location information based on utilizing a location determination functionality of the user device. For example, the user device may utilize global positioning system (GPS) information to determine a location of the user device. The user device may provide the location information to multiple applications operating on the user device, which may be associated with multiple corresponding user interfaces. For example, the user device may provide directions for display via a user interface associated with a mapping application. Similarly, the user device may provide a set of restaurant reviews for display via a user interface associated with a restaurant review application.

However, utilizing multiple applications to provide information may require excessive user interaction with the user device. Moreover, multiple user interfaces may fail to present information in a uniform manner, thereby resulting in excessive user effort to locate desired information in each user interface. Implementations, described herein, may provide end-to-end location dependent information based on integrating multiple data sets into a single user interface. In this way, the user device may provide information based on the multiple data sets in a uniform presentation, thereby reducing user interactions with the user device to cause the user device to obtain desired information and user effort in locating the desired information in a user interface, thereby improving a user experience, relative to utilizing multiple applications with multiple corresponding user interfaces. Moreover, based on reducing a quantity of user interactions, the user device may reduce utilization of processing resources, power consumption, or the like. Furthermore, based on concurrently processing multiple data sets to provide end-to-end location dependent information, the user device may automatically filter one or more data sets based on one or more other data sets, thereby reducing a utilization of memory resources associated with storing data and reducing a utilization of processing resources associated with analyzing data relative to analyzing each data set separately.

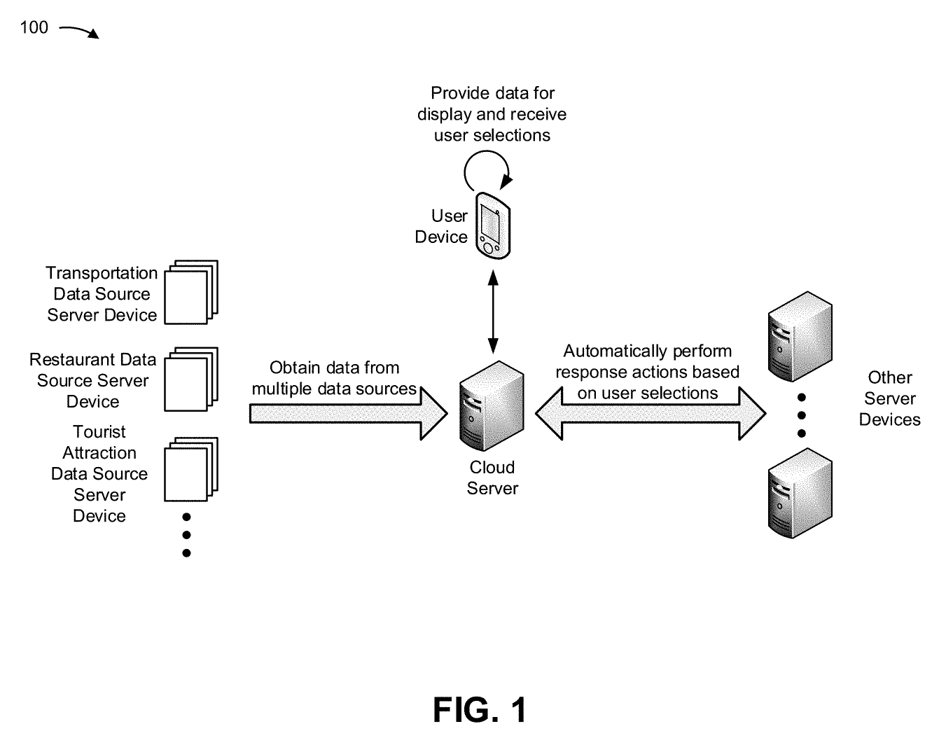

FIG. 1 is a diagram of an overview of an example implementation 100 described herein. As shown in FIG. 1, example implementation 100 may include a cloud server, a user device, and a set of server devices (e.g., application server devices, transaction server devices, data source server devices, or other service devices). The cloud server may obtain multiple data sets relating to a location (e.g., a location of the user device) from multiple data source server devices. For example, the cloud server may obtain a transportation data set (e.g., traffic data, map data, etc.), a restaurant data set (e.g., reviews of restaurants, availability of restaurants, etc.), a tourist attraction data set (e.g., information identifying locations of tourist attractions, reviews of tourist attractions, etc.), or the like. The cloud server may generate a plan based on the data obtained from the multiple sources. A plan may include a set of activities, such as a transit type activity (e.g., a user of the user device traveling from a first location to a second location), an event type of activity (e.g., the user viewing a movie, visiting a tourist attracting, etc.), a dining type of activity (e.g., delivery food, dine-in food, take-out food, etc.), a lodging type of activity (e.g., a stay at a hotel, a stay at a bed-and-breakfast, etc.), or the like.

As an example, the cloud server may generate a day trip plan based on the multiple data sets. In this case, the cloud server may utilize traffic data and transportation data of the transportation data set to determine a distance that the user can travel in a day, and may filter the restaurant data set and the tourist attraction data set to omit data entries relating to restaurants, tourist attractions, or the like located beyond the distance that the user can travel in a day. Similarly, the cloud server may omit particular activities based on a time-frame for the activity and transportation data. For example, the cloud server may omit data entries relating to lunch restaurants located beyond the distance the user can travel prior to lunchtime. As another example, when the cloud server selects a first activity (e.g., a tourist attraction) at a first location, the cloud server may omit data entries related to a restaurant beyond a threshold proximity from the first location for a meal that is to occur within a threshold amount of time of the first activity.

The cloud server may utilize the tourist attraction data set to identify a set of tourist attractions for the user to visit. The cloud server may utilize the restaurant data set to identify a restaurant at which the user is to have a meal. The cloud server may utilize the transportation data sets to identify directions for the user, identify public transportation options for the user, or the like. The cloud server may provide information to the user device, for display via a single user interface, such as information identifying one or more identified tourist attractions, one or more identified restaurants, one or more identified public transportation options, or the like. For example, the cloud server may provide, for display, a set of reviews, a set of maps, a potential schedule, or the like. A potential schedule might include information regarding where to be at what time and an estimated cost of each activity (e.g., cost for entry to tourist attraction, cost for meal, cost for fuel, cost for tolls, etc.).

In some implementations, the cloud server may utilize the multiple data sets to perform a selection. For example, the cloud server may select a particular mode of transportation associated with a user arriving at a destination at a particular time, a particular tourist attraction as a destination based on a user preference, an expected amount of time for visiting the particular tourist attraction, a particular restaurant with a reservation available at a time after the user is expected to be finished visiting the tourist attraction, or the like. In this way, the cloud server performs an improved selection relative to individually selecting a mode of transportation, a tourist attraction, a restaurant, etc. without utilizing multiple data sources to perform each selection.

In some implementations, the cloud server may automatically perform a set of response actions based on a particular plan (e.g., a set of selections). For example, the cloud server may automatically generate a user interface to provide, for display, information associated with the particular plan, a set of maps including directions for the user, or the like. As another example, the cloud server may automatically obtain stored transaction information (e.g., a stored credit card number, a stored bank account number, etc.) and reserve a rental car for the user, a hotel room for the user, or the like. As another example, the cloud server may reserve a table at a restaurant, place an order for food delivery at a scheduled time, or the like. As another example, the cloud server may automatically generate a set of calendar entries for activities of the particular plan, organize photos captured by the user device into a photo album associated with the particular plan, or the like.

In this way, the cloud server reduces utilization of processing resources and improves network performance relative to the user device separately accessing multiple different servers to perform multiple different data requests for the user. Moreover, the cloud server reduces power consumption of the user device based on providing an end-to-end location dependent plan to a user, relative to the user obtaining information via multiple different user interfaces associated with multiple applications of the user device to manually generate a plan.

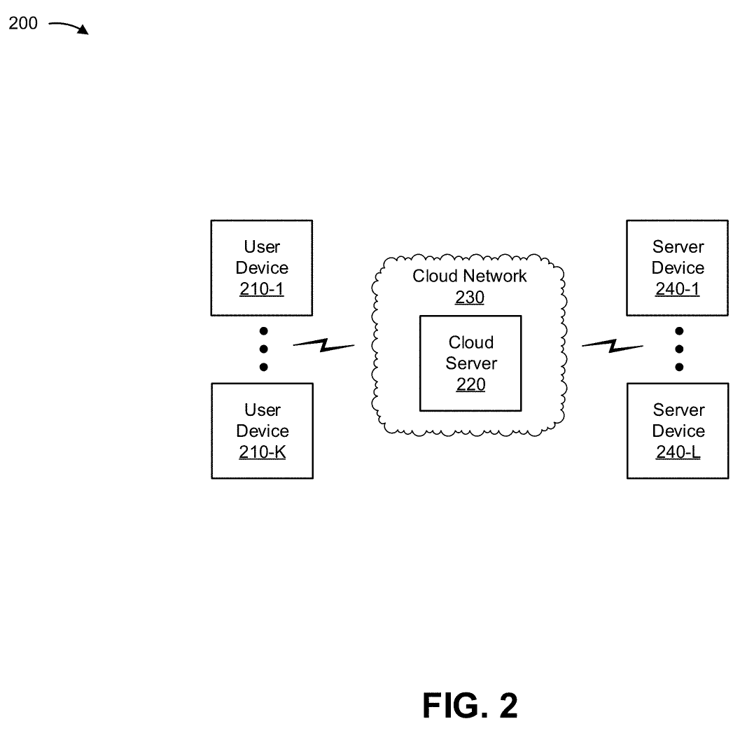

FIG. 2 is a diagram of an example environment 200 in which systems and/or methods, described herein, may be implemented. As shown in FIG. 2, environment 200 may include one or more user devices 210-1 through 210-K (K≧1) (hereinafter referred to collectively as “user devices 210,” and individually as “user device 210”), a cloud server 220, a cloud network 230, and one or more server devices 240-1 through 240-L (L≧1) (hereinafter referred to collectively as “server devices 240,” and individually as “server device 240”). Devices of environment 200 may interconnect via wired connections, wireless connections, or a combination of wired and wireless connections.

User device 210 may include one or more devices capable of receiving, generating, storing, processing, and/or providing information associated with a plan. For example, user device 210 may include a communication and/or computing device, such as a mobile phone (e.g., a smart phone, a radiotelephone, etc.), a laptop computer, a tablet computer, a handheld computer, a gaming device, a wearable communication device (e.g., a smart wristwatch, a pair of smart eyeglasses, etc.), or a similar type of device. In some implementations, user device 210 may include a location determination functionality. For example, user device 210 may determine a location (e.g., based on GPS data), and may utilize the location to generate a plan, provide directions associated with the plan, or the like. In some implementations, user device 210 may receive information from and/or transmit information to another device in environment 200.

Cloud server 220 may include one or more devices capable of storing, processing, and/or routing information associated with a plan. For example, cloud server 220 may include a server that provides end-to-end location dependent information, such as a plan, a portion of a plan, or the like, based on multiple data sets obtained from multiple data sources, such as from user device 210, a set of server devices 240, or the like. In some implementations, cloud server 220 may store information regarding a user (e.g., a set of user preferences, user credit card information, user bank account information, user loyalty or rewards points information, user gift card information, user membership information, etc.), and may process the stored information to generate a plan for a user. In some implementations, cloud server 220 may include a communication interface that allows cloud server 220 to receive information from and/or transmit information to other devices in environment 200. While cloud server 220 will be described as a resource in a cloud computing network, such as cloud network 230, cloud server 220 may operate external to a cloud computing network in some implementations. For example, cloud server 220 may include a physical server, an application operating on user device 210, or the like.

Cloud network 230 may include an environment that delivers computing as a service, whereby shared resources, services, etc. may be provided by cloud server 220 to store, process, and/or route information associated with a plan. Cloud network 230 may provide computation, software, data access, storage, and/or other services that do not require end-user knowledge of a physical location and configuration of a system and/or a device that delivers the services (e.g., cloud server 220). As shown, cloud network 230 may include cloud server 220 and/or may communicate with user device 210 via one or more wired or wireless networks.

Server device 240 may include one or more devices capable of storing, processing, and/or routing information. For example, server device 240 may include a server that is associated with processing a transaction, such as a food delivery order, a transportation purchase (e.g., a train ticket purchase, a car service reservation, etc.), a lodging purchase (e.g., a hotel reservation), or the like. In some implementations, server device 240 may process a currency related transaction, such as a credit card based purchase, a gift card based purchase, a bank account transfer based purchase, or the like. Additionally, or alternatively, server device 240 may process a non-currency related transaction, such a loyalty points based transaction, a membership based transaction (e.g., a transaction to receive a good or service based on possession of a membership rather than a payment, such as receiving a hotel room upgrade based on possessing a hotel loyalty status, receiving access to dinner at a private club based on membership to the private club, etc.), or the like.

In some implementations, server device 240 may include a server that is associated with managing data associated with an entity, such as a restaurant, an entertainment venue, a hotel, a website, or the like. In some implementations, server device 240 may provide information. For example, server device 240 may provide information identifying an availability of rooms at a hotel, images corresponding to available rooms at the hotel, information identifying services available at the hotel, or the like. In some implementations, server device 240 may manage a reservation. For example, server device 240 may receive a selection of an available room, and may reserve the available room based on receiving the selection. In some implementations, server device 240 may provide review information and/or receive review information. For example, server device 240 may provide reviews of a set of hotels, a set of restaurants, a set of attractions, or the like and/or receive a review for incorporation into the reviews. In some implementations, server device 240 may provide an application programming interface (API). In some implementations, server device 240 may include a communication interface that allows server device 240 to receive information from and/or transmit information to other devices in environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. For example, although user device 210 and cloud server 220 are described as separate devices, user device 210 and cloud server 220 may be integrated into a single device. Additionally, or alternatively, a set of devices (e.g., one or more devices) of environment 200 may perform one or more functions described as being performed by another set of devices of environment 200.

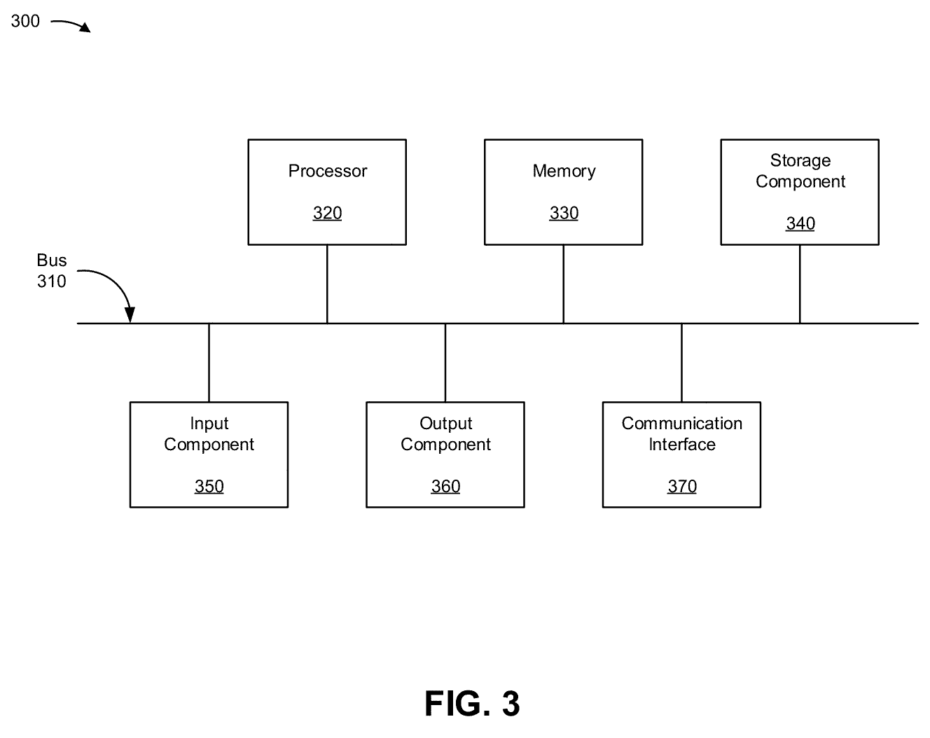

FIG. 3 is a diagram of example components of a device 300. Device 300 may correspond to user device 210, cloud server 220, and/or server device 240. In some implementations, user device 210, cloud server 220, and/or server device 240 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 may include a component that permits communication among the components of device 300. Processor 320 is implemented in hardware, firmware, or a combination of hardware and software. Processor 320 may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. In some implementations, processor 320 may include one or more processors that can be programmed to perform a function. Memory 330 may include a random access memory (RAM), a read only memory (ROM), and/or another type of dynamic or static storage device (e.g., a flash memory, a magnetic memory, an optical memory, etc.) that stores information and/or instructions for use by processor 320.

Storage component 340 may store information and/or software related to the operation and use of device 300. For example, storage component 340 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of non-transitory computer-readable medium, along with a corresponding drive.

Input component 350 may include a component that permits device 300 to receive information, such as via user input (e.g., a touch screen display, a keyboard, a keypad, a mouse, a button, a switch, a microphone, etc.). Additionally, or alternatively, input component 350 may include a sensor for sensing information (e.g., a global positioning system (GPS) component, an accelerometer, a gyroscope, an actuator, etc.). Output component 360 may include a component that provides output information from device 300 (e.g., a display, a speaker, one or more light-emitting diodes (LEDs), etc.).

Communication interface 370 may include a transceiver-like component (e.g., a transceiver, a separate receiver and transmitter, etc.) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a non-transitory computer-readable medium, such as memory 330 and/or storage component 340. A non-transitory computer-readable medium is defined herein as a non-transitory memory device. A memory device includes memory space within a single physical storage device or memory space spread across multiple physical storage devices.

Software instructions may be read into memory 330 and/or storage component 340 from another non-transitory computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

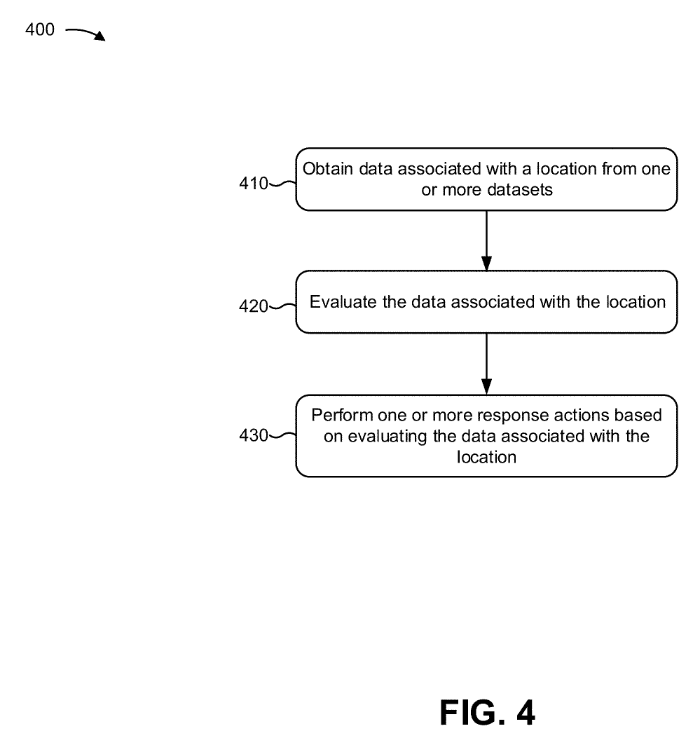

FIG. 4 is a flow chart of an example process 400 for providing end-to-end location dependent information. In some implementations, one or more process blocks of FIG. 4 may be performed by cloud server 220. In some implementations, one or more process blocks of FIG. 4 may be performed by another device or a group of devices separate from or including cloud server 220, such as user device 210 and/or server device 240.

As shown in FIG. 4, process 400 may include obtaining data, associated with a location, from one or more data sets (block 410). For example, cloud server 220 may obtain the data from the one or more data sets. The data may refer to information obtained from one or more data sets that is associated with a potential plan for one or more activities at one or more locations. The one or more activities may include a transportation activity (e.g., transportation from a first location to a second location), a meal activity (e.g., eating food at a restaurant, obtaining take-out food from a restaurant, ordering delivery food from a restaurant, etc.), an event activity (e.g., going to a movie, visiting a tourist attraction, etc.), a lodging activity (e.g., a stay at a hotel, a stay at a bed-and-breakfast, a stay at a resort, etc.), or the like.

In some implementations, cloud server 220 may provide a user interface to a user via user device 210, and may obtain the data based on a user interaction with the user interface. For example, cloud server 220 may cause the user interface to be displayed, and may receive a trigger to obtain the data based on the user interacting with the user interface. Additionally, or alternatively, cloud server 220 may receive, from user device 210, location information identifying a location, and may obtain the data associated with the location based on receiving the location information identifying the location.

In some implementations, cloud server 220 may obtain location data relating to a current location of a user. For example, cloud server 220 may obtain, from user device 210, a current location of user device 210, which may be utilized for generating directions to an activity of a plan, obtaining data regarding activities within a particular proximity (e.g., a particular travel distance, a particular travel time based on traffic data, or the like) of the current location of user device 210, or the like. In this case, cloud server 220 may include a particular activity in a set of activities regarding which to obtain data based on determining that a travel time to from the current location of the user being less than a maximum time for travel for the user (e.g., as indicated in user preference data for the user, a default configuration, or the like). Additionally, or alternatively, cloud server 220 may obtain location data relating to another location. For example, a user may indicate (e.g., via interaction with a user interface of user device 210) that the user intends to travel or is interested in traveling to another location, and cloud server 220 may obtain location data regarding the other location.

In some implementations, cloud server 220 may obtain user preference data from a user preference data set of the one or more data sets. For example, cloud server 220 may obtain data regarding a user preference relating to a portion of a plan, such as a preferred type of food, a preferred mode of transportation, a preferred genre of entertainment, or the like. In some implementations, cloud server 220 may obtain the user preference data based on querying the user. For example, cloud server 220 may provide one or more user interface elements of a user interface (e.g., via user device 210) identifying a set of potential user preferences (e.g., types of food), and may receive a selection of a particular user preference (e.g., pizza, hamburgers, Kosher, vegetarian, etc.) of the set of potential user preferences. Additionally, or alternatively, cloud server 220 may perform a data mining technique to obtain the user preference data. For example, based on receiving a user permission and/or access, cloud server 220 may data mine one or more server devices 240 storing a user browsing history, a user social media history, a user credit card transaction history, a user communication activity (e.g., emails, voicemails, telephone calls, instant messages, etc.), a user television or movie watching history, one or more previously generated plans, or the like to determine user preference data. Additionally, or alternatively, cloud server 220 may obtain user preference data from server device 240 (e.g., a data source storing user preference data) based on requesting user preference data.

In some implementations, cloud server 220 may obtain user selection data from a user selection data set of the one or more data sets. For example, cloud server 220 may obtain a user selection of one or more selection options, such as a type of plan (e.g., a custom generated plan, a template-based plan, etc.), a template of a plan (e.g., a template relating to a day trip, a weekend trip, a shopping trip, etc.), or the like based on providing a user interface via user device 210. In this case, cloud server 220 may provide, via the user interface of user device 210, information associated with permitting a user to select portions of a plan, information identifying portions of a plan (e.g., reviews of activities, costs of activities, etc.) to facilitate a user selection, or the like. Based on providing information via a single user interface, cloud server 220 may reduce a quantity of user interactions with user device 210 that a user performs to obtain desired information, thereby reducing processing resources utilized by user device 210, power consumption of user device 210, network traffic caused by user device 210, or the like, relative to the user accessing multiple user interfaces associated with multiple applications.

In some implementations, cloud server 220 may obtain offer data from one or more offer data sets of the one or more data sets. For example, cloud server 220 may utilize location data to obtain one or more commercial offers (e.g., an offer for sale, a discount, etc.) available to a user of user device 210. In this way, cloud server 220 can incorporate discount offers into recommendations for an activity for a user. For example, when cloud server 220 receives an offer for a free first product with purchase of a second product at a particular store and cloud server 220 determines that the user is likely to desire the first product and the second product based on user preference data, cloud server 220 may recommend a shopping activity for the user. In this way, cloud server 220 increases a likelihood of a store receiving shoppers with reduced computing resources utilized relative to the store operating a separate server device 240 for providing offers to user devices 210.

In some implementations, cloud server 220 may obtain activity data from one or more activity data sets of the one or more data sets. For example, cloud server 220 may obtain information identifying a set of restaurants (e.g., names of restaurants, locations of restaurants, menus of restaurants, reviews of restaurants, reservation availability of restaurants, etc.), a set of entertainment options (e.g., names of movie theaters, tourist attractions, or the like, reviews of movies, tourist attractions, or the like, availability information regarding movie theaters, tourist attractions, or the like, etc.), or the like. In some implementations, cloud server 220 may obtain the activity data from a set of server devices 240. For example, cloud server 220 may obtain first activity data from a first server device 240 storing restaurant review data, second activity data from a second server device 240 storing restaurant availability data for a first restaurant, third activity data from a third server device 240 storing restaurant availability data for a second restaurant, or the like. In this way, cloud server 220 automatically obtains multiple different data sets to provide information regarding an activity, thereby reducing a quantity of user interactions with a user interface required to obtain similar information relative to requiring first set of user interactions to navigate a web browser to a set of restaurant reviews, a second set of user interactions to navigate a web browser to restaurant availability, or the like. Moreover, based on cloud server 220 automatically identifying one or more activities within a particular proximity of the location and obtaining information regarding the one or more activities, cloud server 220 reduces a utilization of memory resources for storing activity data relative to obtaining data regarding activities not within the particular proximity of the location.

As further shown in FIG. 4, process 400 may include evaluating the data associated with the location (block 420). For example, cloud server 220 may automatically evaluate the data from the one or more data sets. In some implementations, cloud server 220 may generate a plan based on the data. For example, cloud server 220 may identify a set of types of activities (e.g., a transportation activity, a dining activity, an entertainment activity, a lodging activity, etc.), and may order the set of types of activities into a plan of multiple activities (e.g., first a transportation activity, second a dining activity, third a transportation activity, fourth an entertainment activity, fifth a transportation activity, etc.). In some implementations, cloud server 220 may generate the plan based on a template plan. For example, based on user selection data indicating that a user desires a plan for a day trip, cloud server 220 may generate a plan that includes a set of activities for a single day. Similarly, based on user selection data indicating that a user desires a plan for a single activity, such as a food delivery or the like, cloud server 220 may generate a plan that includes the single activity.

In some implementations, cloud server 220 may automatically evaluate the data to identify a set of potential activities for a portion of a plan. For example, when generating a portion of a plan relating to a transportation activity, cloud server 220 may identify a set of modes of transportation that are associated with satisfying a particular requirement (e.g., transporting the user from a first location to a second location, satisfying a cost threshold, satisfying a time threshold, or the like). In this case, cloud server 220 may filter the data to identify a subset of data relating to the set of modes of transportation that are associated with satisfying the particular requirement. Similarly, cloud server 220 may filter the data to identify one or more restaurants that satisfy a restaurant requirement (e.g., providing a particular type of cuisine, satisfying a cost threshold, providing a delivery option, accepting credit cards for payment, etc.). In this way, cloud server 220 may reduce an amount of data that is to be processed when performing a selection of a particular activity (e.g., a particular mode of transportation, a particular restaurant, etc.), thereby reducing a utilization of memory resources, processing resources, or the like relative to processing all the data to perform the selection.

Additionally or alternatively, cloud server 220 may determine that one or more activities are located greater than a threshold distance from a location of another activity. For example, cloud server 220 may determine that a first activity (e.g., a movie) is located at a first location, and that a second activity (e.g., a restaurant) is located at a second location, which is greater than a threshold distance from the first location. In this case, cloud server 220 may remove the second activity from a set of potential activities for the plan. In this way, cloud server 220 may reduce network utilization by automatically filtering out the second activity, relative to the user being presented with the second activity and having to manually utilize a mapping application to determine a location of the first activity, a location of the second activity, and a distance between the first activity and the second activity.

In some implementations, cloud server 220 may filter data based on a user preference. For example, cloud server 220 may, based on a user preference, determine that a user does not prefer to stay at a particular brand of hotel, and may remove the particular brand of hotel from the set of hotels. In this way, cloud server 220 may reduce an amount of data that is provided to a user for selection, relative to a user being provided with data regarding all hotels and the user being required to provide feedback associated with filtering the data.

In some implementations, cloud server 220 may automatically evaluate the data to perform a selection. For example, cloud server 220 may select a restaurant, a mode of transportation, a movie, a tourist attraction, a hotel, or the like for a plan based on the data, a subset of the data, or the like. In some implementations, cloud server 220 may utilize data associated with multiple data sets to perform a selection, such as selecting a movie for a user to attend based on map data, traffic data, movie theater data, user preference data, movie review data, or the like. In this case, cloud server 220 may utilize map data to identify a set of movie theaters within a particular proximity to the user, traffic data to determine an estimated time of arrival for the user at each movie theater of the set of movie theaters, and movie theater data to identify one or more movies at each movie theater that are exhibited after a corresponding estimated time arrival at each movie theater. Moreover, cloud server 220 may select a particular movie from the set of movies based on the user preference data and the movie review data. For example, cloud server 220 may utilize a review score, may perform natural language processing or another text analysis technique on a newspaper review to identify keywords (e.g., genre keywords, such as comedy, drama, action, etc., recommendation keywords, such as must see, avoid, appropriate for children, etc., or the like), or the like.

In this way, cloud server 220 may reduce a likelihood that information provided to a user is irrelevant to the user or results in a selection that the user does not enjoy, relative to the user being provided information regarding a set of movies at exhibition times that the user could not attend or selecting a movie without utilizing user preference data or review data. In another example, cloud server 220 may utilize calendar data associated with a user calendar to omit one or more movies from the selection based on the one or more movies being projected to end at a time at which the user would be unable to travel to a calendar appointment occurring after the movie. In this way, cloud server 220 may reduce a likelihood that an activity is suggested that causes the user to be late to another activity.

In some implementations, cloud server 220 may generate a score for one or more selections. For example, cloud server 220 may generate multiple plans for a user, such as a plan for lunch and a movie, a plan for a snack and site-seeing, a plan for takeout food and a car service to a public park, or the like, and may generate a score for each plan based on user preference data, review data, a cost determination, or the like. In this case, cloud server 220 may select a particular plan for the user based on the score. In some implementations, cloud server 220 may determine a set of scores for portions of each plan of a set of plans. For example, cloud server 220 may determine a first score for a first activity of a first plan, a second score for a second activity of the first plan, a third score for a first activity of a second plan, etc., apply a weight to each score, and select a particular plan based on a combined weighted score. In some implementations, cloud server 220 may select the weights based on user preference data, user selection data, or the like. For example, cloud server 220 may determine that a user has provided a review of a first restaurant and may apply a first weight to an activity of dining at the first restaurant and may determine that review data from other users is available for a second restaurant and may apply a second weight to an activity of dining at the second restaurant. In this case, the first weight and second weight may represent a confidence that a score for each restaurant (determined based on the user review and the review data, respectively) will accurately reflect user enjoyment of each restaurant. Additionally, or alternatively, a set of weights may reflect a predicted level of user interest in a corresponding activity and plan (e.g., based on user preference data or the like). Additionally, or alternatively, a set of weights and/or an associated score may represent an estimated likelihood that a particular user will prefer a particular activity relative to another activity.

In some implementations, cloud server 220 may evaluate the data to select a subset of data for display to a user via a user interface of user device 210. For example, cloud server 220 may select one or more restaurants, from a set of restaurants, based on availability and/or reviews of the set of restaurants, and may select review data, location data, price data, or the like to be provided to a user. Similarly, cloud server 220 may identify one or more modes of transportation for the user to travel from a location of the user to a location of each restaurant of the one or more restaurants, and may select data identifying the one or more modes of transportation (e.g., an amount time for each mode of transportation, a cost of each mode of transportation, or the like) to be provided for display via the user interface. In this way, cloud server 220 integrates multiple data sets obtained from multiple data sources into a single user interface, thereby improving user experience relative to a user being required to navigate multiple user interfaces that present data in multiple different locations, with multiple different user interface elements, or the like. Moreover, based on reducing user interactions with user device 210 relative to utilizing multiple user interfaces, cloud server 220 may reduce utilization of processing resources, utilization of memory resources, and power consumption of user device 210. Furthermore, based on automatically evaluating multiple data sets to select information from the multiple data sets to be provided for display to a user, cloud server 220 may improve network performance by reducing a quantity of messages that are exchanged between user device 210 and cloud server 220 to identify data that is to be provided for display. Additionally, cloud server 220 may obviate the need for user device 210 to connect to multiple server devices 240 to obtain data, thereby reducing network utilization by user device 210.

As further shown in FIG. 4, process 400 may include performing one or more response actions based on evaluating the data associated with the location (block 430). For example, cloud server 220 may perform one or more response actions based on evaluating the data regarding the plan. In some implementations, cloud server 220 may provide information associated with the plan as a response action based on evaluating the data regarding the plan. For example, cloud server 220 may provide information identifying a selected plan, of a set of plans, for display via a user interface of user device 210. In this case, cloud server 220 may generate multiple presentations of the user interface, such as multiple pages or the like, that each present information in a similar manner (e.g., utilizing the same template for each page). In some implementations, cloud server 220 may provide information identifying multiple options for an activity. For example, cloud server 220 may provide information identifying multiple modes of transportation, costs of the multiple modes of transportation, expected times of arrival associated with the multiple modes of transportation, or the like. In this case, cloud server 220 may receive, based on a user interaction with a user interface of user device 210, a selection of a particular mode of transportation for the plan.

In some implementations, cloud server 220 may provide a recommendation. For example, cloud server 220 may determine an expected meal cost for a set of restaurants based on evaluating the data, and may provide a recommendation of a particular restaurant, of a set of potential restaurants at which to reserve a table for the user, based on determining the expected meal cost. Additionally, or alternatively, cloud server 220 may determine that a particular transaction option, of a set of transaction options, results in a lowest relative cost to a user, and may recommend the particular transaction option for paying at the particular restaurant. For example, when cloud server 220 evaluates data regarding potential transaction options (e.g., a set of credit cards with corresponding loyalty programs, a gift card, a coupon, etc.), cloud server 220 may provide a recommendation of a particular credit card associated with a cashback program that minimizes a cost to the user, a particular credit card associated with a rewards program that maximizes a rewards benefit to the user, or the like. Additionally, or alternatively, cloud server 220 may identify a set of locations (e.g., a set of neighborhoods, a set of tourist attractions, etc.) to which the user can travel within a particular period of time based on evaluating data regarding traffic, modes of transportation, time expected to be spent at each location, or the like.

In some implementations, cloud server 220 may provide a score associated with a recommendation. For example, when cloud server 220 generates a set of scores for a set of plans, cloud server 220 may provide information identifying the set of plans and the set of scores, a threshold quantity of plans of the set of plans and the corresponding threshold quantity of scores (e.g., one or more plans associated with the highest relative scores), or the like.

In some implementations, cloud server 220 may place a reservation associated with the plan as a response action based on evaluating the data regarding the plan. For example, cloud server 220 may automatically exchange one or more messages with one or more server devices 240 associated with a restaurant to reserve a table for a user at a time that the user is expected to arrive at the restaurant. Additionally, or alternatively, cloud server 220 may reserve lodging, a mode of transportation (e.g., a train ticket, a car service, etc.), or the like.

In some implementations, cloud server 220 may schedule a reservation. For example, cloud server 220 may determine that a car service is to be requested for the user at a particular time, may schedule requesting the car service for a particular time, and may request the car service at the particular time. In some implementations, cloud server 220 may modify a reservation. For example, cloud server 220 may receive updated location data, updated traffic data, or the like and may determine that a user is expected to arrive at a different time than a scheduled time of a reservation. In this case, cloud server 220 may automatically exchange messages with one or more server devices 240 to change a time of the reservation to the different time.

In some implementations, cloud server 220 may execute a transaction associated with the plan based on evaluation of the data regarding the plan. For example, cloud server 220 may exchange one or more messages with one or more server devices 240 to order food for delivery, take-out, or the like. Additionally, or alternatively, cloud server 220 may pay for lodging, a tourist attraction, a movie, or the like. For example, cloud server 220 may provide a user interface with which to receive a selection of a seat at a concert from a user of user device 210, receive a selection, and purchase the seat at the concert for the user. In this way, cloud server 220 may reduce a user effort in selecting a seat by providing a consistent presentation relative to the user experiencing multiple different information presentations when selecting a seat in multiple different contexts.

In some implementations, cloud server 220 may execute the transaction based on selecting a particular mode of payment of a set of payment options. For example, cloud server 220 may determine a score for a set of payment options (e.g., based on a cost to the user, a benefit to the user, etc.), may select a particular payment option (e.g., a particular credit card) from the set of payment options, and may utilize the particular payment option, for reserving a hotel room, thereby reducing a cost associated with the hotel room, improving benefits offered to the user by the hotel operator (e.g., a discounted price, an upgraded room, etc.), or the like. Similarly, cloud server 220 may automatically use mileage points associated with a loyalty program and earned by a user to book an airplane flight for the user. Similarly, cloud server 220 may utilize a gift card possessed by a user (e.g., for which cloud server 220 has received information associated with utilizing the gift card) to perform a purchase for the user. In this way, cloud server 220 reduces an amount of processing resources used by user device 210 to locate information identifying the multiple credit cards, loyalty programs, gift cards, or the like for the user to utilize.

In some implementations, cloud server 220 may obtain second data after evaluating first data regarding the plan. For example, cloud server 220 may evaluate first data regarding the plan to select a particular restaurant, and may obtain second data regarding tourist attractions within a particular proximity of the particular restaurant. In this case, cloud server 220 may evaluate the second data, perform a set of response actions based on the second data, or the like.

In some implementations, cloud server 220 may generate updated information for the user interface. For example, cloud server 220 may monitor user device 210 to determine a location of user device 210, to determine whether a user has completed an activity of a plan, or the like, and may generate updated information based on monitoring user device 210. In this case, the updated information may include another recommendation of an activity, another set of potential activities for user selection, updated travel directions, different travel directions (e.g., directions for travel from the completed activity to another activity), or the like.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

In this way, cloud server 220 may provide end-to-end location dependent information via a user interface, such as information identifying a plan that includes a set of different activities. Moreover, cloud server 220 may provide recommendations to a user of user device 210, perform transactions for a user of user device 210, establish reservations for a user of user device 210, set calendar entries for a user of user device 210, or the like.

Based on generating a single user interface to receive user selections and/or provide information associated with evaluating data from multiple data sets, cloud server 220 reduces an amount of processing resources that are utilized by user device 210 relative to a user utilizing multiple applications of user device 210. Moreover, cloud server 220 reduces a quantity of messages that are exchanged between user device 210 and cloud server 220 and/or server devices 240 to obtain information desired by a user relative to a user being required to manually filter data, thereby improving network performance for cloud server 220 and user device 210.

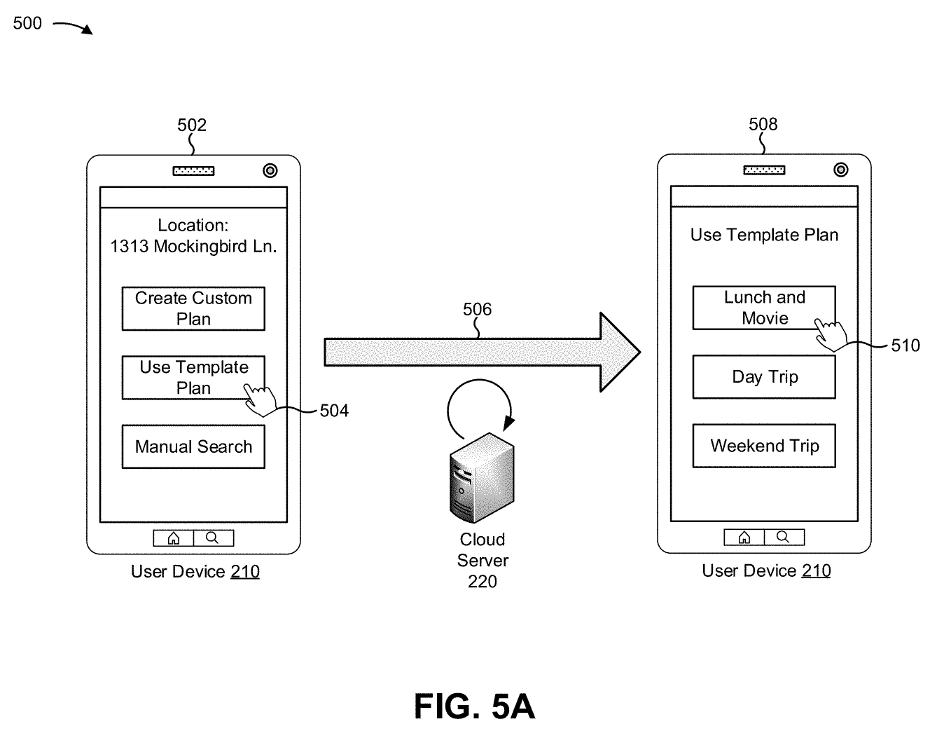

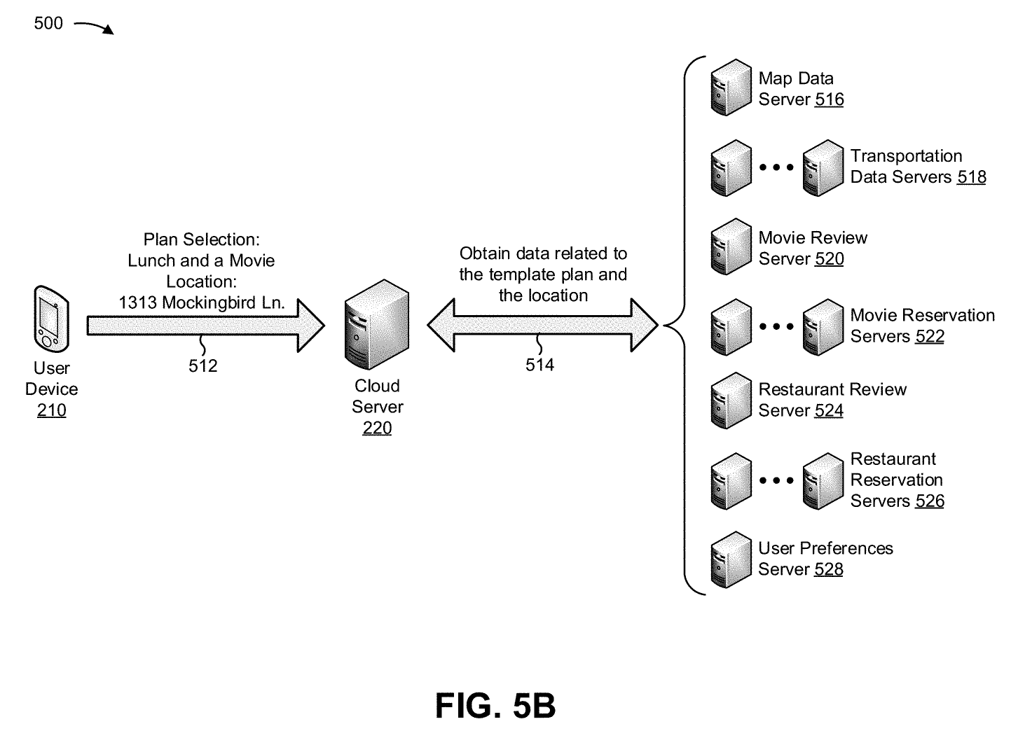

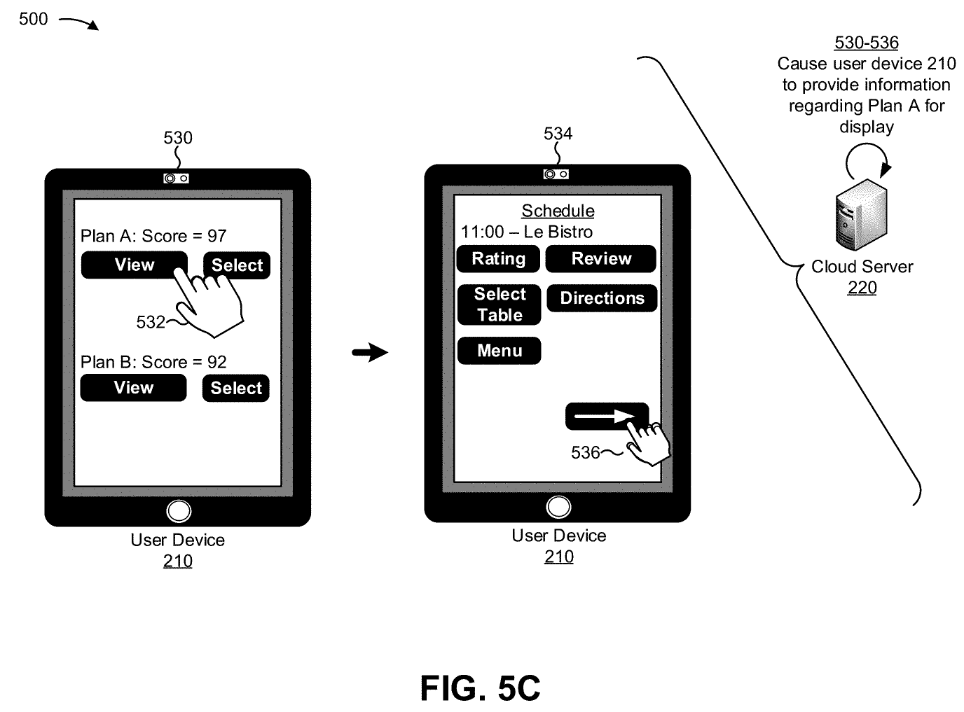

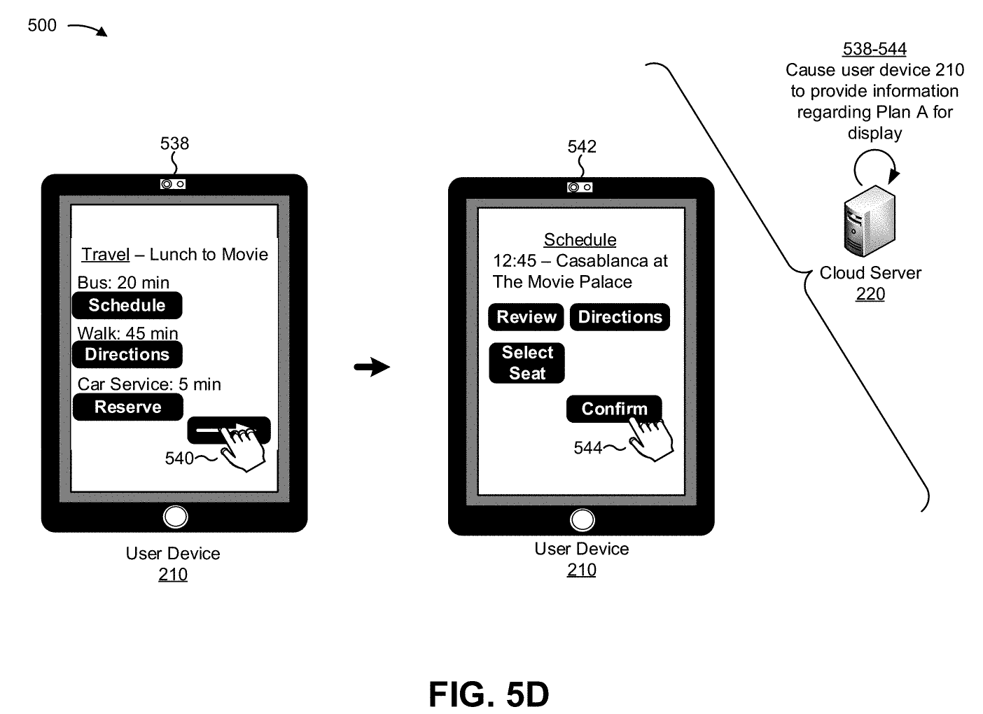

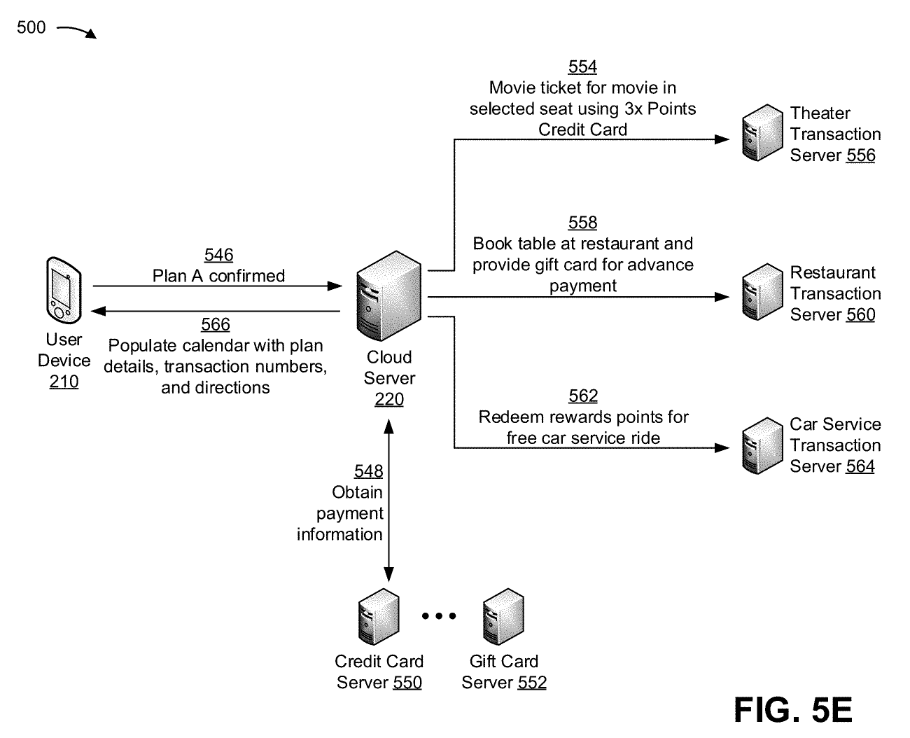

FIGS. 5A-5E are diagrams of an example implementation 500 relating to example process 400 shown in FIG. 4. FIGS. 5A-5E show an example of providing end-to-end location dependent information.

As shown in FIG. 5A, cloud server 220 provides, via user device 210, a user interface identifying a set of options for user selection. The set of options identify types of plans that cloud server 220 can generate for a user. As shown by reference number 504, user device 210 may receive a user selection for cloud server 220 to generate a plan based on a template plan. As shown by reference number 506 and 508, cloud server 220 receives information identifying the user selection, and causes the user interface to be updated to provide information identifying a set of template plans (e.g., Lunch and Movie, Day Trip, and Weekend Trip). As shown by reference number 510, user device 210 may detect a user selection of the Lunch and Movie template plan.

As shown in FIG. 5B, and by reference number 512, cloud server 220 receives information identifying the user selection of the Lunch and Movie template and a location of the user (e.g., 1313 Mockingbird Ln.). As shown by reference number 514, cloud server 220 obtains multiple data sets relating to the user selected template plan and the location. For example, cloud server 220 may obtain a data set regarding the location of the user from map data server 516, a data set regarding modes of transportation from transportation data servers 518 (e.g., a first server associated with train reservations, a second server associated with car service reservations, etc.), a data set regarding reviews of currently exhibited movies from movie review server 520, a data set regarding availability of tickets from movie reservation servers 522 (e.g., a first reservation server device 240 associated with a first movie theater, a second reservation server device 240 associated with a second movie theater, etc.), a data set regarding reviews of restaurants within a particular proximity to the user from restaurant review server 524, a data set regarding user preferences from user preferences server 528 (e.g., a preferred type of movie, a preferred type of food, a set of credit cards possessed by the user, a set of loyalty programs in which the user is enrolled, etc.), or the like. Assume that cloud server 220 generates a set of plans based on the multiple data sets.

As shown in FIG. 5C, and by reference numbers 530-536, cloud server 220 provides information identifying the set of plans for display via user device 210. As shown by reference number 530, based on receiving the information identifying the set of plans, user device 210 is caused by cloud server 220 to display a user interface identifying a first plan, Plan A, and a first score, 97, and a second plan, Plan B, and a second score, 92. Assume that the scores represent a determination by cloud server 220 of an expected likelihood that the user of user device 210 will enjoy each plan. As shown by reference number 532, based on a user interaction with the user interface, cloud server 220 receives an indication that the user desires to view Plan A. As shown by reference number 534, cloud server 220 causes user device 210 to provide information identifying a first activity of Plan A (e.g., lunch at a restaurant, Le Bistro). The user interface includes user interface elements for the user to view a rating of the restaurant, view a review of the restaurant, select a particular table at the restaurant, view directions to the restaurant, or view a menu of the restaurant without the user being required to access another application of user device 210, a website, or the like. As shown by reference number 536, based on a user interaction with a user interface element of the user interface, cloud server 220 is caused to provide information regarding a second activity of the Plan A.

As shown in FIG. 5D, and by reference numbers 538-544, cloud server 220 causes user device 210 to provide information regarding Plan A. As shown by reference number 538, cloud server 220 causes information regarding travel from the restaurant to a movie theater to be provided via a user interface of user device 210. For example, cloud server 220 includes a set of transportation options with a set of estimated times (e.g., Bus: 20 min, Walk: 45 min, Car Service: 5 min). For the Bus option, cloud server 220 includes a user interface element for causing user device 210 to display a bus schedule. For the Walk option, cloud server 220 includes a user interface element for causing user device 210 to display directions. For the Car Service option, cloud server 220 includes a user interface element for causing cloud server 220 to reserve the car service when the plan is selected. Assume that the user selects the user interface element associated with causing user device 210 to reserve the car service, and user device 210 transmits an indication of the user selection to cloud server 220. As shown by reference number 540, based on a user interaction with another user interface element of the user interface, cloud server 220 is caused to provide information regarding a third activity of Plan A.

As further shown in FIG. 5D, and by reference number 542, cloud server 220 causes information regarding a movie at the movie theater to be provided via a user interface of user device 210. For example, cloud server 220 includes information identifying the movie, Casablanca, and the movie theater, The Movie Palace, and a set of user interface elements associated with causing user device 210 to provide, for display, a review, directions to return to a current location of user device 210 from the movie theater, an option to select a particular seat at the movie theater, or the like. Assume that the user selects a particular seat, and user device 210 transmits an indication of the selection to cloud server 220. As shown by reference number 544, based on a user interaction with another user interface element of the user interface, user device 210 is caused to provide an indication of user confirmation of Plan A to cloud server 220.

As shown in FIG. 5E, and by reference number 546, cloud server 220 receives the indication of the user confirmation of Plan A. Based on receiving the indication of the confirmation, cloud server 220 performs a set of response actions. As shown by reference number 548, cloud server 220 obtains payment information from a set of servers, such as credit card server 550, gift card server 552, or the like. For example, cloud server 220 may obtain payment information identifying a set of credit cards, a set of gift cards, a rewards account, or the like. As shown by reference number 554, cloud server 220 purchases a movie ticket for Casablanca at The Movie Palace in a seat selected by the user based on exchanging messages with theater transaction server 556. Cloud server 220 utilizes payment information associated with a particular credit card earning triple rewards points for the user based on obtaining the payment information.

As further shown in FIG. 5E, and by reference number 558, cloud server 220 reserves a table at Le Bistro for the user and provides information identifying a gift card to restaurant transaction server 560 to pay for the lunch in advance. As shown by reference number 562, cloud server 220 redeems rewards points from a rewards account with car service transaction server 564 to reserve a free car service ride for the user. As shown by reference number 566, cloud server 220 populates a calendar of user device 210 with details of Plan A, transaction confirmation numbers, and directions, thereby permitting the user to view information associated with Plan A. In this way, cloud server 220 generates, reserves, and pays for a lunch and movie plan for a user without the user being required to utilize different user interfaces providing different presentations of data, thereby reducing user interaction with user device 210 and improving performance of user device 210 (e.g., reducing utilization of processing resources, reducing power consumption, reducing a quantity of messages transmitted via a network, or the like).

As indicated above, FIGS. 5A-5E are provided merely as an example. Other examples are possible and may differ from what was described with regard to FIGS. 5A-5E.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, and/or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

Certain user interfaces have been described herein and/or shown in the figures. A user interface may include a graphical user interface, a non-graphical user interface, a text-based user interface, etc. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A device, comprising:
one or more processors to:
obtain data from a plurality of data sources;
automatically evaluate the data to generate a set of recommendations, where each recommendation of the set of recommendations relates to a particular user;
provide information identifying the set of recommendations for display via a single user interface,
the set of recommendations relating to activities within a threshold distance of the particular user,
the threshold distance being a travel distance determined based on traffic data;
receive information associated with accepting the set of recommendations based on providing the information identifying the set of recommendations; and
perform a set of response actions for the particular user based on the set of recommendations and after receiving the information associated with accepting the set of recommendations.

2. The device of claim 1, where the set of recommendations relate to a set of activities for the particular user; and
where the one or more processors, when automatically evaluating the data, are to:
filter the data from the plurality of data sources to identify a subset of data;
select a set of potential activities based on the subset of data;
determine a score for each activity of the set of potential activities,
the score representing an estimated likelihood that the particular user will prefer a particular activity relative to other activities of the set of potential activities based on the subset of data,
the subset of data including review data for the set of potential activities, user preference data relating to the particular user, and traffic data relating to travel to the set of potential activities; and
generate the set of recommendations based on the score for each activity of the set of potential activities.

3. The device of claim 1, where the one or more processors, when automatically evaluating the data, are further to:
identify user preference data included in the data,
the user preference data including a set of keywords associated with a set of user preferences;
perform a text analysis technique to identify one or more data entries, of a set of data entries of the data, associated with a keyword of the set of keywords; and
where providing the information identifying the set of recommendations comprises:
providing information identifying the one or more data entries.

4. The device of claim 1, where the one or more processors, when performing the set of response actions, are to:
exchange one or more messages with a reservation server device to place a reservation for the particular user,
the reservation relating to a particular recommendation of the set of recommendations.

5. The device of claim 1, where the one or more processors, when performing the set of response actions, are to:
exchange one or more messages with a transaction server device to perform a transaction for the particular user,
the transaction relating to a particular recommendation of the set of recommendations.

6. The device of claim 1, where the one or more processors, when performing the set of response actions, are to:
cause information, associated with two or more data sources of the plurality of data sources, to be provided for display via a user interface.

7. The device of claim 1, where the one or more processors, when providing information identifying the set of recommendations, are to:
provide information, via a user interface, identifying a set of selection options; and
where the one or more processors, when receiving information associated with accepting the set of recommendations, are to:
receive a selection of a particular selection option of the set of selection options; and
where the one or more processors, when performing the set of response actions, are to:
perform a particular response action associated with the particular selection option,
the particular response action being different from one or more other response actions associated with one or more other selection options of the set of selection options.

8. A non-transitory computer-readable medium storing instructions, the instructions comprising:
one or more instructions that, when executed by one or more processors, cause the one or more processors to:
provide a user interface for display via a user device;
detect a first one or more user interactions with the user interface,
the first one or more user interactions being associated with specifying one or more user preferences for an activity;
obtain data regarding a set of potential activities based on the one or more user preferences for the activity and a location of the user device;
generate updated information based on the set of potential activities,
the updated information being associated with identifying the set of potential activities associated with the location and a recommendation related to the set of potential activities;
provide the updated information for display via the user interface;
detect, based on providing the updated information for display via the user interface, a second one or more user interactions with the user interface,
the second one or more user interactions being associated with selecting a plurality of activities of the set of potential activities; and
perform a set of response actions based on detecting the second one or more user interactions with the user interface,
the set of response actions including reserving the plurality of activities and providing, for display via the user interface, directions associated with travel from the location of the user device, to a location of a first activity of the plurality of activities.

9. The computer-readable medium of claim 8, where the recommendation is a commercial offer; and
where the one or more instructions, when executed by the one or more processors, further cause the one or more processors to:
receive, from a server device associated with an entity within a particular proximity to the location, the commercial offer relating to a user of the user interface; and
where the one or more instructions, that cause the one or more processors to generate the updated information, further cause the one or more processors to:
include the commercial offer as the recommendation.

10. The computer-readable medium of claim 8, where the one or more instructions, when executed by the one or more processors, further cause the one or more processors to:
provide, for display via the user interface, information identifying one or more available seats at a particular activity of the plurality of activities;
detect a particular user interaction with the user interface associated with selecting a particular seat of the one or more available seats; and
where the one or more instructions, that cause the one or more processors to perform the set of response actions, cause the one or more processors to:
reserve the particular seat.

11. The computer-readable medium of claim 8, where the one or more instructions, when executed by the one or more processors, further cause the one or more processors to:
determine that a user of the user device has completed the first activity of the plurality of activities; and
provide, based on determining that the user of the user device has completed the first activity, information identifying updated directions associated with travel from the location of the user device to a location of a second activity of the plurality of activities.

12. The computer-readable medium of claim 8, where the one or more instructions, that cause the one or more processors to perform the set of response actions, cause the one or more processors to:
obtain data regarding a set of payment options, associated with the set of potential activities, that are available to a user of the user device;
generate a set of payment option scores corresponding the set of payment options;
select a particular payment option, of the set of payment options, as the recommendation based on the set of payment option scores; and
automatically perform a payment for a particular activity, of the plurality of activities, using the particular payment option.

13. The computer-readable medium of claim 8, where the plurality of activities includes at least two of:
a transit type of activity,
an event type of activity,
a dining type of activity, or
a lodging type of activity.

14. The computer-readable medium of claim 8, where the one or more instructions, that cause the one or more processors to obtain data regarding the set of potential activities, further cause the one or more processors to:
determine a maximum time for travel for a user of the user device based on the one or more user preferences;
determine, based on traffic data, that for each activity of the set of potential activities, a particular time for travel is less than the maximum time for travel; and
select each activity, of the set of potential activities, for the set of potential activities based on determining that, for each activity of the set of potential activities, the particular time for travel is less than the maximum time for travel.

15. A method, comprising:
obtaining, by a device, a plurality of data sets relating to a plurality of activities of a plan;
processing, by the device, the plurality of data sets to select the plurality of activities for the plan,
the plurality of activities including a plurality of types of activities;
providing, by the device, a presentation of information relating to the plan via a single user interface of a user device based on selecting the plurality of activities for the plan,
the information relating to the plurality of activities including information identifying directions for traveling to a first activity selected for the plan, of the plurality of activities for the plan, and to a second activity selected for the plan, of the plurality of activities for the plan, from the first activity,
the information relating to the plurality of activities being associated with the plurality of types of activities;
performing, by the device, a set of response actions associated with the plan based on selecting the plurality of activities for the plan;
monitoring, by the device, a location of the user device; and
providing, by the device, updated information regarding the plan via the single user interface of the user device based on the location of the user device,
the updated information including updated directions for traveling or an updated selection of activities.

16. The method of claim 15, where the plurality of types of activities includes at least one of:
an event type of activity,
a dining type of activity, or
a lodging type of activity.

17. The method of claim 15, where obtaining the plurality of data sets comprises:
performing a data mining technique to obtain one or more data sets of the plurality of data sets.

18. The method of claim 15, where processing the plurality of data sets comprises:
determining the location of the user device;
identifying a set of potential activities within a threshold proximity to the location of the user device; and
selecting, from the set of potential activities, a particular activity for the plan,
the particular activity being included in the plurality of activities.

19. The method of claim 15, where performing the set of response actions comprises:
automatically reserving a particular seat at an event for a user.

20. The method of claim 15, where performing the set of response actions comprises:
populating a set of calendar entries corresponding to the plurality of activities to a calendar associated with the user device.
